(19) United States
(12) Patent Application Publication
(10) Pub. No.: US 2006/0155761 A1
(43) Pub. Date: Jul. 13, 2006

(54) Enhanced organization and retrieval of digital images

(76) Inventors: Bartel Marinus Van De Sluis, Eindhoven (NL); Elmo Marcus Attila Diederiks, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/562,509

(22) PCT Filed: Jun. 24, 2004
(86) PCT No.: PCT/IB04/51000

§ 371 Date: Dec. 28, 2005

Related U.S. Application Data
(60) Provisional application No. 60/483,799, filed on Jun. 30, 2003.

(51) Int. Cl. G06F 17/00

(52) U.S. Cl. 707/104.1

(57) ABSTRACT

A system for organizing and retrieving digital photographs using global positioning system coordinates, comprising a digital camera 2 having a positioning system receiver for capturing a digital image, a first database 21 storing the digital image data along with positioning system coordinates of the location where the image was taken, a second database 22 for storing positioning system coordinate information and associated location names of a plurality of locations; and a processor 25 for determining the positioning system coordinates of the digital image stored in the first database 21, searching the second database 22 for matching positioning system coordinates, and if a match is found storing the location name with the digital image data in the first database 21.

The invention relates generally to enhanced organization and retrieval of digital images, and more particularly to enhanced organization and retrieval of digital photographs using global positioning system coordinates, date stamp, and/or time stamp.

The global positioning system (GPS) has long been utilized to determine a position of a person or object. The GPS has been incorporated into many commercial electronics, including portable telephones, wristwatches, and the like. Recently, GPS cameras have been introduced into the market. These digital cameras contain a GPS receiver that coordinate-stamps each digital photograph with the exact GPS coordinates of the global position where the picture was taken.

FIG. 1. is a diagram of a conventional GPS camera system. Shown in FIG. 1 are GPS system 1, GPS camera 2, a representation of digital image data and GPS coordinate information 3, and PC (Personal Computer) 4. Digital camera 2 receives GPS coordinates from GPS system 1, and upon taking a photograph, GPS camera stores the digital image data along with the GPS coordinates of the GPS camera 2 at the time the image is taken. At a later time the user can download the image data and GPS coordinate information 3 into PC 4 for storage and viewing. In addition, when a digital image is taken, even in a non-GPS camera, a date and time stamp is also stored with the digital image data.

The GPS coordinates that are associated with a digital image are being widely used to enhance the experience while viewing and managing the images. U.S. Pat. No. 6,437,797 describes a system that utilizes the GPS data associated with an image to superimpose a thumbnail of the image on a map image to enable the viewer to see where the image was taken. U.S. Pub. No. 2001/0022621 discloses a camera and cellular telephone system that stamps a digital image with GPS coordinate location information and current-user data. Also of interest is JP Pub. No. 09-027937 that discloses an apparatus that records a location name or address of an image having associated GPS data by searching a database containing location name and address information associated with GPS coordinates, and associates the location name or address with the image based on the GPS data. Also, U.S. Pat. No. discloses an information retrieval system that stores in a database position data (longitude and latitude) associated with a URL Universal Resource Locator) of a home page in a WWW (World Wide Web) server. When a user selects an image with associated GPS data, the system searches the database for GPS data at or near the GPS data of the image, and opens the home page associated therewith.

Although, each of these systems enhances the experience while viewing and managing digital images, there are several shortcomings of the current advancements that leave the user still wanting. Although the prior art systems can provide a digital image with a date and time stamp, a user cannot determine if that date and time coincides with a date and time special to the user. Also, the searching and sharing of digital images from a particular location raises confusion when using a GPS coordinate system.

There is a need to have a digital image retrieval and management system for organizing and retrieving digital photographs using global positioning system (GPS) coordinates, comprising a digital camera having a GPS receiver for capturing a digital image, a first database storing the digital image data along with GPS coordinates of the location where the image was taken, a second database for storing GPS coordinate information and associated location names of a plurality of locations; and a processor for determining the GPS coordinates of the digital image stored in the first database, searching the second database for matching GPS coordinates, and if a match is found storing the location name with the digital image data in the first database.

Accordingly, there is also a need for a method for organizing and retrieving digital photographs using global positioning system (GPS) coordinates, comprising capturing a digital image and storing the digital image data along with GPS coordinates of the location where the image was taken, storing GPS coordinate information and associated location names of a plurality of locations; and determining the GPS coordinates of the digital image, searching the first database for matching GPS coordinates, and if a match is found storing the location name with the digital image data.

In another aspect the second database is located at a location remote from the first database.

Yet in another aspect, the Internet connects the first and second databases.

It is yet another aspect of the present invention to provide a system for searching digital image databases based on a GPS coordinate and date and time stamp.

These and other features of the present invention will be apparent to those skilled in the art from the following detailed description, taken together with the accompanying drawings, in which like reference numerals refer to like parts.

FIG. 1. is a diagram of a conventional GPS camera system.

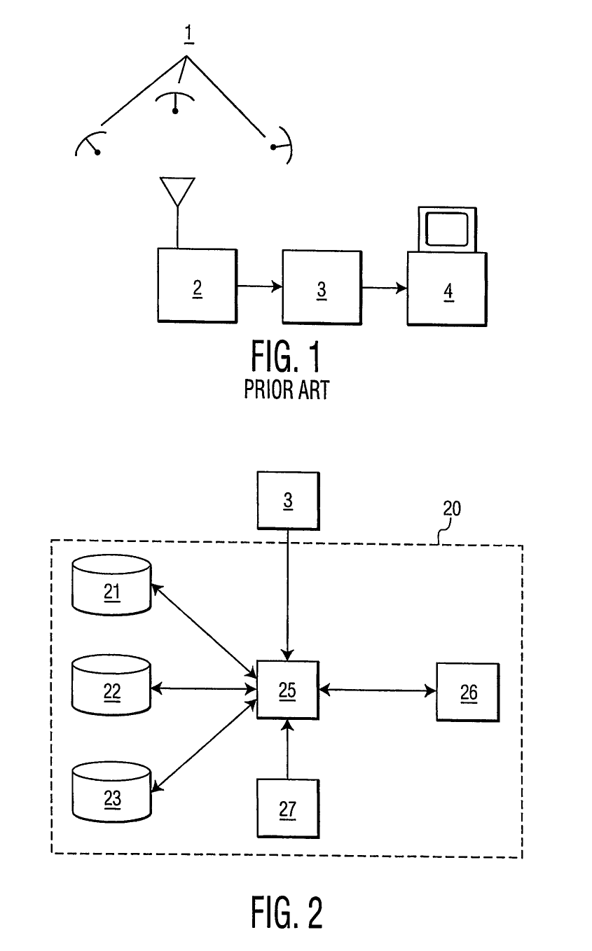

FIG. 2 is a diagram illustrating a digital image retrieval and management system according to an embodiment of the present invention.

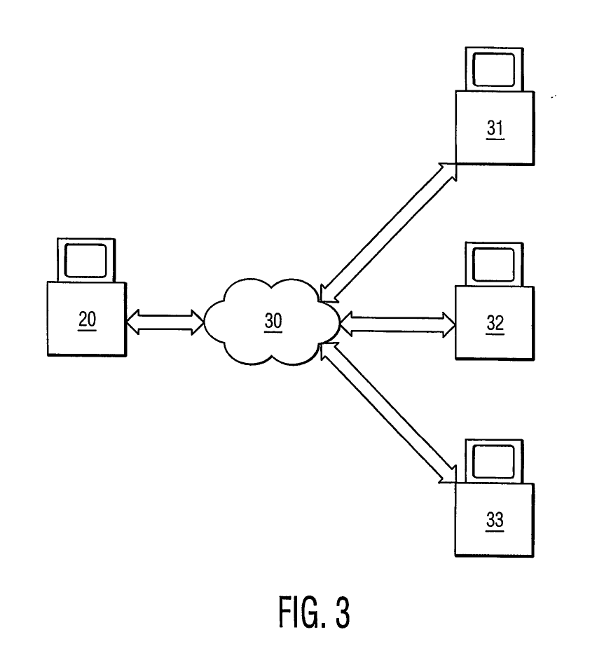

FIG. 3 is a diagram illustrating a digital image retrieval and management system according to another embodiment of the present invention.

A preferred embodiment of the present invention will be described herein below with reference to the accompanying drawings. In the following description, well-known functions or constructions are not described in detail since they would obscure the invention in unnecessary detail.

FIG. 2 is a diagram illustrating a digital image retrieval and management system according to an embodiment of the present invention. Shown in FIG. 2 are digital image data and GPS coordinate information 3, and PC 20. PC 20 is not limited to a personal computer, and can include a web server, personal digital assistant, or other data storage and display system. Contained in PC 20 are digital image data and GPS coordinate information database 21, GPS/location name database 22, date/occasion database 23, and processor 25. Also shown is input device 27, which can be, but is not limited to, a keyboard, touch screen or other input device.

The digital image data and GPS coordinate information 3 is input from the GPS camera (not shown) to PC 20, and in particular into processor 25. Processor 25 then stores the digital image data and GPS coordinate information 3 in digital image data and GPS coordinate information database 21. GPS/location name database 22 stores GPS coordinates of known locations associated with location name information of the locations. For example, the Eiffel Tower in Paris has the following coordinates: latitude N 48° 51′ 32″ and longitude E 002° 17′ 35″. GPS/location name database 22 would store the location name “Eiffel Tower” and its GPS coordinates “48.51.32.002.17.35”. Of course, the format of the information stored can vary with system requirements. When a digital image and GPS coordinates are stored in digital image data and GPS coordinate information database 21, processor searches GPS/location name database 22 for a matching GPS coordinate of a stored location. So in the above example, if a digital image of the Eiffel Tower is taken, the digital image data and GPS coordinates where the photograph was taken are stored in digital image data and GPS coordinate information database 21. Processor 25 would than begin a search of GPS/location name database 22 for matching GPS coordinates. Upon finding the match of N 48° 51′ 32″ and E 002° 17′ 35″, processor 25 would store the label “Eiffel Tower” along with the digital image data in digital image data and GPS coordinate information database 21.

The search parameters of processor 25 can be adjusted to widen or narrow a search. For example, if the GPS coordinates of the Eiffel Tower are used as the search coordinates, processor 25 could be programmed to not only provide the location name “Eiffel Tower” for association with the digital image data, but could be programmed to also provide the label “Paris” as an alternative location name. Both location names could be stored or the user could be given an option of which location name to select using input device 27. And, if a user desires to narrow a search, the system is instructed to retrieve a location label of an exact or near matching GPS coordinates. So, for example, is a user takes a digital image while in his backyard, processor 25 conducts a narrow search an retrieves a particular street address associates with the GPS coordinates of the digital image, rather than a village name or nearby tourist attraction location name. Similarly, if a matching GPS coordinate is not found by processor 25 while searching GPS/location name database 22, processor 25 can be programmed to find a nearest or several near matching GPS coordinates, and allow the user to select using input device 27 which location name or names to store with the digital image data. Also, a user could be allowed to edit the stored location names using input device 27 as well as input and store GPS coordinate information and location names for locations not in GPS/location name database 22 using input device 27.

Also shown in FIG. 2 is the date/occasion database 23. Standard information recorded by a digital camera, with or without a GPS receiver, is the date and time at which the photograph is taken. Of course, a more accurate date and time would be available with a GPS camera, as the correct date and time is available from the GPS system. In either case, the data and time information is stored as part of the digital image data from the digital camera in the digital image data and GPS coordinate information database 22.

Date/occasion database 23 stores known dates associated with specific occasions occurring on the dates. For example, Christmas occurs on December 25 of each year. Date/occasion database 23 would store the date “12.25” and its occasion “Christmas”. Again, the format of the information stored can vary with system requirements. When a digital image containing the date a photograph was taken is stored in digital image data and GPS coordinate information database 21, processor searches date/occasion database 23 for a matching date of a stored occasion. So, in our example, if a digital image is taken on December 25^{th}, the digital image date, of when the photograph was taken is stored in digital image data and GPS coordinate information database 21. Processor 25 would than begin a search of date/occasion database 23 for a matching date. Upon finding the match of “12.25”, or a similar format, processor 25 would store the occasion label “Christmas” along with the digital image data in digital image data and GPS coordinate information database 21. Processor 25 can be programmed to also store the year of the occasion along with the occasion name, e.g. “Christmas 2003”. If a matching date is not found by processor 25 while searching date/occasion database 23, processor 25 can be programmed to allow the user to enter a date and occasion using input device 27, upon which processor 25 would store the entered location label with the digital image data. Additionally, the search performed by processor 25 can be programmed to find on or about dates. This will provide the user with, for example, the occasion “Christmas” even though the photograph was taken on December 24^{th} or December 26^{th}. Also, a user could be allowed to edit the stored dates and occasions using input device 27 as well as input personalized dates and occasions not already stored in date/occasion database 23 using input device 27. For example, a user might input “Richard's birthday” and “June 2” as a user specific occasion and date. Processor 25 would store “Richard's birthday” and “06.02” in date/occasion database 23 for later reference. Or additionally, a birth year or year of a wedding can be stored, and then processor 25 can be programmed to store the year of the occasion or a similar label along with the occasion name, e.g. “Richard's birthday 2003”, or calculate a particular number from the stored year, e.g. “Richard's 30^{th} birthday”.

In the above outlines embodiments, additional functions can now be provided to the user to facilitate the digital image viewing and management experience. Now that location name label and occasion label have been stored with each digital image data, the system can be programmed to search on the new label. For example, a user could desire to retrieve all of the images of Christmas from all years past. In the past, a search would first have to be made using the date parameter of “12/25”, then search date parameters that are close, e.g. “12/24” and “12/26”. Finally, each photo would have to be previewed in order to determine if they are actually of a Christmas related occasion. With the present invention, only one search would be conducted to retrieve all of the Christmas images, and without the need to preview each image, as each image has been stored with an occasion label. Similar searches can be conducted with the location name label also.

FIG. 3 is a diagram illustrating a digital image retrieval and management system according to another embodiment of the present invention. Shown in FIG. 3 are PC 20, Internet 30, and computers 31-33. Computers 31-33 can be other personal computers, Internet web servers, or other computers with Internet access. In this embodiment, each of the computers 31-33 and PC 20 each store digital image data and GPS coordinate information on their respective systems. Currently there are many web sites that cater to amateur and professional photographers. Many of these sites allow a user to upload digital image data onto their web servers for sharing and viewing by others. The present invention will facilitate sharing and viewing of images. A first user can upload or share his digital image data to one of computers 3 1-33. The digital image data would also include at least one of the location name label and occasion label. When a second user conducts a search based on a particular label, the system would retrieve all of the photographs with the same or similar labels. For example, the second user might conduct a search of “Eiffel Tower”, desiring to view other images of the Eiffel Tower. The system would retrieve all of the images with the “Eiffel Tower” location name label. A similar search can be conducted using the occasion label.

Although the present invention has been described thus far in terms relating to digital images, the present invention can also be applied to other image formats. The digital image data disclosed herein includes images taken with a digital camera, a digital video system, a “web cam” (web camera), image scanner, or other device designed to capture an image or sequence of images in a digital format. And although the term “digital camera” or “Digital image data” is used herein for simplicity purposes, all digital image capturing devices and digital image formats are contemplated.

Further the system can use the time and location information for each digital image to group particular sets of photos for the user (e.g. in a photo album or folder). This can provide the user with a meaningful name for the set of images using the time and place information. For example, images taken in Paris during a period of a few consecutive days can be grouped together in an album. The system analyzes the position coordinates and dates of the images, and if matches are found, groupings can be made, the system suggests or assigns, depending on the programming, an appropriate name to the album, such as “Paris—May 2003”, “weekend in Paris”, “Christmas in Paris”. When searching and grouping in this manner, the system is instructed to broaden its search parameters to encompass wider geographical areas and/or date ranges. Of course, the adjustment to the search parameters can be user controlled to narrow or widen the search and allow the user to accurately define the groups.

Another embodiment of the present invention relates to combining a GPS coordinate search with a data and time stamp search. Becoming more commonplace in society are web cams positioned at stationary locations throughout the world. A user can access the real-time images captured by these web cam via the Internet and view real-time video streams. So for example, there might be a web cam positioned and directed at the Eiffel Tower, and a user can access the images captured by the web cam and view the images on his home computer. Or, as commonly practiced in amusement parks, a still image is often taken of passengers while on a particular ride. Both of these formats can be archived, along with GPS coordinates and a date/time stamp. As stated above, the date and time an image is taken is typically stored with the digital image data, along with the GPS coordinate information when a GPS camera is utilized. Therefore, a user who has taken a digital image while at the Eiffel Tower or at the amusement park, instructs processor 25 to conduct a search to retrieve images taken by the web cam or park camera at or about the GPS coordinates and date and time the user took his image. This search can be an Internet-wide search or can be limited to a particular web site, for example, the web site of the Eiffel Tower tourist information division or the web site of the amusement park. This provides the user with images or video that coincides with the place and time the user was at tat location, whereby the images might actually contain images of the user himself. These retrieved images can then be provided to the user at no cost or for a fee.

Although a GPS system is referred to throughout this disclosure, it will be understood by one skilled in the art that other positioning systems are equally contemplated for use herein.

While the invention has been described with reference to several embodiments, it will be understood by those skilled in the art that the invention is not limited to the specific forms shown and described. Thus, various changes in form and details may be made therein without departing from the spirit and scope of the invention as defined by the appended claims.

1. A system for organizing and retrieving digital images, comprising:
a first database for storing first data and digital image data;
a second database for storing second data; and
a processor for searching the second data based on the first data, and storing the second data associated with the first data.

2. The system of claim 1, wherein a search of the digital image data can be conducted based on the associated second data.

3. The system of claim 2, wherein the first data includes a date that the digital image data was originally captured, and the second data includes at least one occasion and a date of the at least one occasion.

4. The system of claim 2, wherein the first data includes positioning system coordinates where the digital image data was originally captured, and the second data includes at least one location name and the positioning system coordinates of the at least one location name.

5. The system of claim 1, wherein the second database is located at a location remote from the first database.

6. The system of claim 5, wherein the Internet connects the first and second databases.

7. A system for organizing and retrieving digital images using global positioning system coordinates, comprising:
a digital camera having a positioning system receiver for capturing a digital image;
a first database storing the digital image data along with positioning system coordinates of the location where the image was taken;
a second database for storing positioning system coordinate information and associated location names of a plurality of locations; and
a processor for determining the positioning system coordinates of the digital image stored in the first database, searching the second database for matching positioning system coordinates, and if a match is found storing the location name with the digital image data in the first database.

8. The system of claim 7, wherein a search of the digital images is conducted on the basis of the location name.

9. The system of claim 8, wherein at least one of a date and a time when the image was captured is stored in the first database with the digital image data.

10. The system of claim 9, further comprising a third database for storing at least one occasion and a date of the at least one occasion.

11. The system of claim 10, wherein the processor determines the date of the digital image stored in the first database, searches the third database for a matching date, and if a match is found stores the occasion with the digital image data in the first database.

12. The system of claim 11, wherein the location name and occasion are used as sorting parameters for the associated digital images.

13. The system of claim 9, further comprising a fourth database for storing second digital image data containing positioning system coordinate information and at least one of a data and time the second digital image was captured, the second digital image being captured by another,
wherein a search is conducted of the fourth database based on at least one of the date and time stored in the first database.

14. A method for organizing and retrieving digital images using global positioning system coordinates, comprising:
capturing a digital image and storing in a first database the digital image data along with positioning system coordinates of the location where the image was taken;
storing in a second database positioning system coordinate information and associated location names of a plurality of locations; and
determining the positioning system coordinates of the digital image, searching the second database for matching positioning system coordinates, and if a match is found storing in the first database the location name with the digital image data.

15. The method of claim 14, further comprising the steps of:
storing in the first database with the digital image data the date on which the image was captured; and
storing at least one occasion and a date of the at least one occasion.

16. The method of claim 15, further comprising the steps of:
determining the date of the digital image stored in the first database;
searching the second database for a matching date; and
if a match is found, storing in the first database the occasion with the digital image data.

17. The method of claim 16, further comprising the step of storing in a third database images taken by another along with positioning system coordinate information and at least one of a date and a time stamp.

18. The method of claim 17, further comprising the step of searching the third database to retrieve images having at least one of a matching positioning system coordinates, date and time.

19. The method of claim 19, wherein the third database is located at a location remote from the first database.

20. The method of claim 19, wherein a fee is charged for retrieving the digital image stored in the third database.

21. The method of claim 15, further comprising the steps of:
determining digital images having dates within a first preset range and having positioning system coordinate information within a second preset range; and
labeling the determined images with a location label and an occasion label corresponding to the date range and positioning system coordinate information range.
